(19) United States
(12) Patent Application Publication
(10) Pub. No.: US 2010/0182400 A1
(43) Pub. Date: Jul. 22, 2010

(54) Aligning Images

(75) Inventors: Chad M. Nelson, Oakland, CA (US); Phil Gorrow, Half Moon Bay, CA (US); David Montgomery, Half Moon Bay, CA (US)

Correspondence Address: Innovation Counsel LLP, 21771 Stevens Creek Blvd, Ste. 200A, Cupertino, CA, 95014, US

(73) Assignee: WORLD GOLF TOUR, INC., San Francisco, CA (US)

(21) Appl. No.: 12/355,485

(22) Filed: Jan. 16, 2009

(51) Int. Cl. H04N 3/28; G06K 9/36

(52) U.S. Cl. 348/42; 382/285; 348/E03.05

(57) ABSTRACT

Methods, systems, and apparatus, including computer program products, for aligning images are disclosed. In one aspect, a method includes receiving an inaccurate three-dimensional (3D) position of a physical camera, where the physical camera captured a photographic image; basing an initial 3D position of a virtual camera in a 3D virtual environment on the inaccurate 3D position of the physical camera; correlating one or more markers in the photographic image with one or more markers in the 3D virtual environment that appear in the virtual camera's field of view; and adjusting the initial 3D position of the virtual camera in the 3D virtual environment based on a disparity between the one or more markers' 3D positions in the photographic image as compared to the one or more markers' 3D positions in the virtual camera's field of view.

### BACKGROUND

Electronic games and other types of simulations recreate real world environments such as baseball diamonds, race tracks, and golf courses through three-dimensional (3D) computer generated graphics. However, such graphics can typically create unnatural visual artifacts such as repeating patterns which detract from the intended realism of the imagery. Some electronic games may use a photograph of an actual location as a background, such as mountains, with computer generated graphics rendered in the foreground. However, such graphics rendered in the foreground can still detract from the intended realism of the imagery.

A 3D virtual environment, or a three-dimensional computer generated representation of a physical environment that can portray, for example, topologies, landmarks, and positions thereof, can be used in simulations. Superimposing photographs on the 3D virtual environment can improve the intended realism of the simulation. Positions of cameras used to capture the photographs can be used to perform the superimposing. Ideally, the positions of the cameras should be determined as accurately as possible.

### SUMMARY

This specification relates to aligning images. In some implementations, photographic images (e.g., two dimensional (2D) photographs) can be superimposed on 3D computer generated graphics.

In general, one aspect of the subject matter described in this specification can be embodied in methods that include the actions of receiving an inaccurate three-dimensional (3D) position of a physical camera positioned above a surface in a physical environment corresponding to an actual 3D position of the physical camera where the physical camera captured a photographic image of the physical environment from the actual 3D position and where the photographic image includes a plurality of markers on or above the surface, each marker having a known 3D position on or above the surface; basing an initial 3D position of a virtual camera in a 3D virtual environment on the inaccurate 3D position of the physical camera where the 3D virtual environment includes a 3D representation of the surface and a representation of the markers on or above the surface according to their known 3D positions, and where the virtual camera's field of view is of a portion of the representation of the surface; correlating one or more markers in the photographic image with one or more markers in the 3D virtual environment that appear in the virtual camera's field of view; and adjusting the initial 3D position of the virtual camera in the 3D virtual environment based on a disparity between the one or more markers' 3D positions in the photographic image as compared to the one or more markers' 3D positions in the virtual camera's field of view. Other embodiments of this aspect include corresponding systems, apparatus, and computer program products.

These and other embodiments can optionally include one or more of the following features. The photographic image is a two-dimensional (2D) photographic image. The 3D position of the physical camera is defined by at least one of position data and attitude data. The one or more markers in the photographic image are visual markers. The one or more markers in the photographic image are virtual markers that are generated after the photographic image is captured.

The method further includes superimposing the photographic image over the portion of the 3D virtual environment in the field of view of the virtual camera. The method further includes receiving input matching one or more of the one or more markers in the photographic image to one or more of the one or more markers in the virtual camera's field of view. The correlating includes: minimizing the disparity based on the matching, producing a minimized disparity; and generating a reverse projection of an adjusted 3D position of the virtual camera based on the minimized disparity. The method further includes generating a grid of the 3D virtual environment that includes the virtual camera configured according to the reverse projection. The method further includes calculating the field of view of the virtual camera; and displaying a representation of the field of view on the grid.

Particular embodiments of the subject matter described in this specification can be implemented to realize one or more of the following advantages. Correlating markers in photographic images with markers in 3D virtual environments increases an accuracy of image alignment (e.g., proper position, orientation, and scale). Correlating the markers allows a 3D position of a virtual camera to be calibrated, thereby increasing an accuracy of the 3D position of the virtual camera. As a result, a realism of real world environment re-creations is increased and a user's experience is enhanced by providing the user a simulation that gives the user an impression that the 3D virtual environment was generated using 3D photography. As another result, a quality of shot sequences, based on portions of a 3D virtual environment in fields of view (FOV) of one or more virtual cameras in the 3D virtual environment, can be improved.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example course grid.

FIG. 2A is a photographic image of an example view of a physical environment.

FIG. 2B is an image of an example view of a 3D virtual environment.

FIG. 3 illustrates the photograph of FIG. 2A superimposed on the image of FIG. 2B.

FIG. 4 is a flow chart of an example process for aligning images.

FIG. 5A is a schematic of an example system for aligning images.

FIG. 5B is a schematic of an example alignment tool.

Like reference numbers and designations in the various drawings indicate like elements.

### DETAILED DESCRIPTION

Various implementations recreate a 3D virtual environment (e.g., a computer simulated golf course) utilizing digital representations of actual photographs of a corresponding physical environment combined with computer generated 2D and 3D topographies in a virtual environment. Portions of the virtual environment can be associated with actual photographs captured by one or more physical cameras that correspond to one or more virtual cameras positioned in the virtual environment. Adjusting positions of the one or more virtual cameras can be used to align digital representations of the actual photographs with computer generated 2D and 3D topographies.

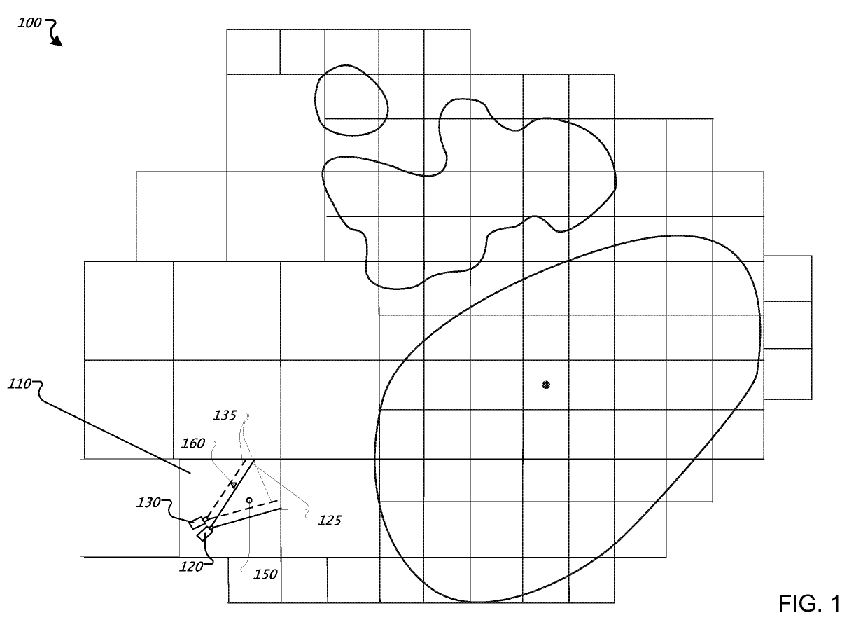

FIG. 1 illustrates an example course grid 100. In some implementations, the course grid 100 can be a grid that divides a hole of a golf course (e.g., a first hole, a second hole, an eighteenth whole), for example, into a plurality of cells (e.g., a cell 110). Each cell can define a physical area of the course that can be photographed for use, for example, in the simulation of a virtual golf course. Each cell can have one or more photographs associated with the cell. For example, the one or more photographs can include views of different angles of the portion of the golf course (e.g., views around 360 degrees from any point above or on the cell) corresponding to the area of the cell.

Each photograph associated with the cell can be associated with a virtual camera that corresponds to a physical camera that captured the photograph. For example, the cell 110 includes a virtual camera 120. The virtual camera 120 can be disposed on the course grid 100 according to an associated 3D position. The 3D position can include a location of the virtual camera 120 (e.g., x-, y-, and z-coordinates) and an orientation (e.g., attitude, pitch) of the virtual camera 120. Initially, the 3D position can be determined from a measured 3D position of a corresponding physical camera in the real world environment.

The measured 3D position of the corresponding physical camera can be determined using global positioning system (GPS) data provided by GPS devices. For example, the physical cameras can include GPS devices that capture GPS data for the position and orientation of the physical camera used to capture each photograph. As another example, a GPS device that is external to the physical camera can be used to capture the GPS data.

The measured 3D position of a corresponding physical camera can be inaccurate. For example, the GPS device may provide GPS data that indicates a measured 3D position of the physical camera that is different from the actual 3D position of the physical camera. Returning to FIG. 1, for example, the 3D position determined from the GPS data can be used to dispose a corresponding virtual camera 120 at the 3D position in the cell 1 10. However, the actual 3D location of the physical camera 130 would indicate that the corresponding virtual camera should have a different 3D position in the cell 1 10. In practice, the virtual camera 120 should have the same 3D position as the actual 3D location of the physical camera 130.

Because the 3D position of the virtual camera 120 is based on an inaccurate measured 3D position of the physical camera 130, the virtual camera 120 also has a field of view 125 that is different from the field of view 135 of the physical camera 130. In other words, a first field of view associated with the virtual camera 120 and a second field of view associated with the physical camera 130 would portray different portions of a representation of the surface of the golf course. The first field of view associated with the virtual camera portrays what a camera would see at the measured 3D position, while the second field of view associated with the physical camera portrays what a camera would see at another 3D position (because the physical camera is not actually disposed at the inaccurate measured 3D position).

Accurately superimposing a photographic image onto a 3D virtual environment, and thereby determining an accurate location of the physical camera, can be facilitated by aligning markers in the photographic image with corresponding markers in the 3D virtual environment.

The physical environment can include markers (e.g., stationary objects such as sprinkler heads, stones, and trees) on or above the surface of the environment. Markers can also be introduced to the environment, on or above the environment. For example, colored cones or washers can be disposed at certain positions in the physical environment. In some implementations, the markers can be visible markers (e.g., the colored cones, or objects on or above the golf course such as sprinkler heads). In some implementations, the markers can be virtual markers. For example, a virtual marker can be generated by using radar to determine a 3D position, on or above the surface of the physical environment, that can be represented by a virtual marker, and metadata can be added to photograph to indicate the virtual marker in a digital representation of the photograph.

Because the virtual camera 120 and the physical camera 130 portray different portions of the virtual environment, alignment of a photographic image captured by the physical camera 130 using a corresponding position (and FOV) of the virtual camera 120 can be inaccurate. A field of view can be defined as a portion of an observable environment that is seen at any given moment by a camera, or an angle extent thereof. The photographic image represents the FOV of the physical camera 130, which is, in reality, different from the FOV of the virtual camera 120. Therefore, the photographic image may not be aligned properly with the virtual environment (e.g., accurately superimposed on the 3D topography).

As shown in FIG. 1, the FOV 135 of the physical camera 130 includes a first object 150 (e.g., a marker represented by a circle) and a second object 160 (e.g., a marker represented by a triangle). Because of an inaccurate measured 3D position used to generate the virtual camera 120, the FOV 125 of the virtual camera 125 does not include the second object 160. Mapping a photographic image captured by the physical camera 130 using the inaccurate 3D position used to generate the virtual camera 120 would produce an inaccurate alignment (e.g., superimposition) of the photographic image on the virtual environment.

3D positions can be determined for each marker. In some implementations, measured 3D positions of the markers can be more accurate (e.g., a disparity of less than 3 inches from the actual location of the marker in the physical environment) than measured 3D positions of the physical cameras. For example, high-precision GPS devices can be used to determine the 3D positions of the markers.

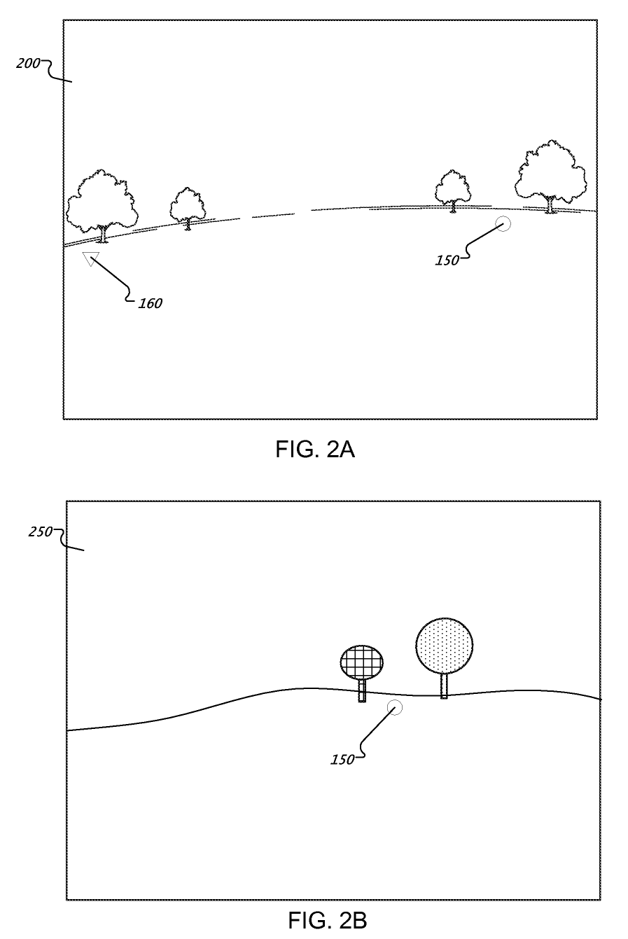

FIG. 2A is a photographic image 200 of an example view of a physical environment. The photographic image 200 shows the field of view 135 of the physical camera 130. The photographic image 200 includes the markers 150 and 160 in the field of view 135. FIG. 2B is an image 250 of an example view of a 3D virtual environment. The view of the 3D virtual environment corresponds to the field of view 125 of the virtual camera 120. As shown in FIG. 2B, the image 250 does not include the marker 160. Ideally, the photographic image 200 would show the same view as in the image 250. However, because the measured 3D position of the physical camera 130 may be inaccurate (e.g., a disparity of 3 inches or more from the actual location of the physical camera in the physical environment), the FOV 135 of the physical camera 130 is not identical to the FOV 125 of the virtual camera 120.

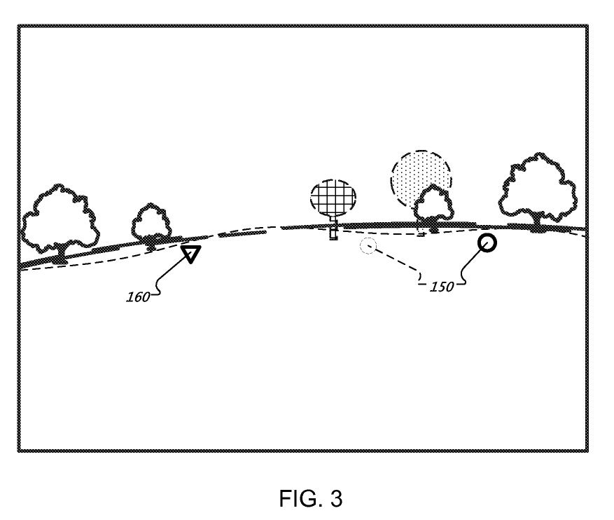

FIG. 3 illustrates the photograph of FIG. 2A superimposed on the image of FIG. 2B. In particular, FIG. 3 illustrates a simple superimposition, where an alignment includes aligning the edges of the images (e.g., the edges of the FOV's). If the photographic image 200 is superimposed on the portion of the 3D virtual environment represented by the image 250, the terrain illustrated by photographic image 200 would not accurately align with the topography of the portion of the 3D virtual environment represented by the image 250. In addition, a first depiction of the first marker 150 (as represented by the circle with a solid boundary) in the photographic image would not align properly with a second depiction of the first marker 150 (as represented by the circle with a dotted boundary). Similarly, depictions of the terrain (e.g. a hill) also would not align properly. Note that a second depiction of the second marker 160 is not visible. If the second marker 160 were an actual object (e.g., a bush) to be included in the golf course, there would not be a photographic image, or portion of a photographic image, to superimpose on a corresponding object in the 3D virtual environment.

Objects and/or markers can be aligned to increase the accuracy of image alignment. In some implementations, the markers can be aligned by correlating markers that should correspond to each other. Markers that correspond to each other can be identified and correlated with each other.

In some implementations, an alignment tool can be used to facilitate selection of corresponding markers. For example, a user can use the alignment tool to select (e.g., click on) the first marker 150 in the photographic image 200 and to select the first marker 150 in the image 250. The user can use a secondary action to correlate (e.g., match) the two selections. For example, the user can press one or more keys on a keyboard (e.g., CTRL+C). As another example, a user can use the alignment tool to select the first marker 150 in the photographic image 200 and drag the selection onto the first marker 150 in the image 250, thereby matching the first marker 150 in the photographic image 200 with the first marker 150 in the image 250. Other implementations are possible. For example, techniques for image recognition or pattern recognition can be used to identify (e.g., automatically) first markers and second markers that should be correlated.

After at least one pair of corresponding markers is identified (e.g., by a user or a recognition technique), a disparity between the corresponding markers in each pair of corresponding markers can be reduced (e.g., minimized). A minimization algorithm can be used to reduce the disparity between the 3D positions of the corresponding markers in each pair of corresponding markers. For example, in some implementations, a multidimensional minimization algorithm, such as Powell's method, can be used.

In particular, the disparities in the 3D positions between corresponding markers in each pair of corresponding markers can be represented by a function z=f(\vec{x})=f(x₁, x₂, . . . , xₙ). Returning to the example illustrated in FIGS. 2A and 2B, n can represent a number of pairs of corresponding markers (e.g., n=2) that have been identified. x₁ can represent a disparity (e.g., an error function) between a first pair of corresponding markers (e.g., 150 in FIG. 2A and 150 in FIG. 2B), and x₂ can represent a disparity between a second pair of corresponding markers (e.g., 160 in FIG. 2A and 160 in FIG. 2B). A minimization algorithm can be used to minimize the disparities.

In some implementations that use Powell's method, \vec{x}₀ can be an initial guess at a location of the minimum of the function z=f(\vec{x}) =f(x₁, x₂, . . . , xₙ). Base vectors \vec{E}ₖ=(0, . . . ,1ₖ,0, . . .,0) can be generated for k=1, 2, 3, . . . , n. Vectors \vec{U}ₖ can be initialized such that \vec{U}ₖ=\vec{E}ₖ for k=1, 2, 3, . . . , n. The transpose of \vec{U}ₖ, or \vec{U}′ₖ, can be used as the columns of a matrix U, such that U=[\vec{U}′₁, \vec{U}′₂, . . . , \vec{U}′ₙ]. A counter i can be initialized to zero (i.e., i=0).

A starting point \vec{p}₀ can be initialized such that \vec{p}₀=\vec{x}ᵢ. For k=1, 2, 3, . . . , n, the value of γ=γₖ that minimizes f(\vec{p}ₖ₋₁+γ·\vec{U}ₖ) can be determined. Then, \vec{p}ₖ can be set such that \vec{p}ₖ=\vec{p}ₖ₋₁+γ·\vec{U}ₖ. In addition, \vec{U}ⱼ can be set such that \vec{U}ⱼ=\vec{U}ⱼ₊₁ for j=1,2,3, . . . ,n−1; and \vec{U}ₙ can be set such that \vec{U}ₙ=\vec{p}ₙ−\vec{p}₀. The counter i can be incremented (i.e., i=i+1). Finally, a value of γ=γₘᵢₙ can be determined that minimizes f(\vec{p}₀+γ·\vec{U}ₙ); and \vec{x}ᵢ can be set such that \vec{x}ᵢ=\vec{p}₀+γₘᵢₙ·\vec{U}ₙ. The steps described in this paragraph (e.g., beginning with initializing \vec{p}₀) can then be repeated until convergence is achieved, and a location of the minimum of the function z can be determined.

Other implementations are possible. For example, other minimization algorithms, such as, but not limited to Newton's method, quasi-Newton methods, and Broyden-Fletcher-Goldfarb-Shanno method can be used.

In some implementations, additional alignment can be performed. For example, the alignment tool can allow a user to view the photographic image superimposed on the virtual environment, based on the minimization. The user can further manually align the photographic image with the virtual environment by manually adjusting the placement (e.g., overlay) of the photographic image over the virtual environment. In this manner, the alignment tool allows a user to reduce the disparity between corresponding markers according to the user's visual inspection of the alignment (and not necessarily minimizing the disparity mathematically). Other implementations are possible.

Reducing the disparity between corresponding markers in pairs of corresponding markers can be viewed as a process that is implicit in or that parallels a process of adjusting (e.g., moving) the 3D position of the virtual camera until a superimposition of the markers in the FOV of the physical camera on the markers in the FOV of the virtual camera provides an improved alignment. After disparities between corresponding markers are minimized, the positions of markers in the virtual environment can be determined, and the positions of the markers in the virtual environment can then be used in a reverse projection (e.g., an overlay of the photographic image on the virtual environment) to determine a more accurate 3D position of the virtual camera. The determined 3D position of the virtual camera can then be used to define a more accurate 3D position of the physical camera.

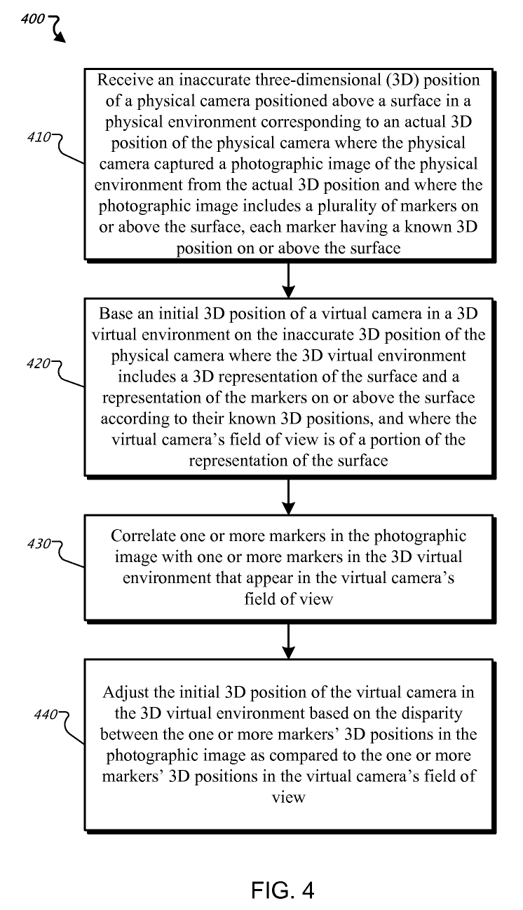

FIG. 4 is a flow chart of an example process 400 for aligning images. The process 400 includes receiving 410 an inaccurate 3D position of a physical camera positioned above a surface in a physical environment corresponding to an actual 3D position of the physical camera where the physical camera captured a photographic image of the physical environment from the actual 3D position and where the photographic image includes a plurality of markers on or above the surface, each marker having a known 3D position on or above the surface. For example, an alignment tool can receive an inaccurate 3D position of the physical camera 130.

The process also includes basing 420 an initial 3D position of a virtual camera in a 3D virtual environment on the inaccurate 3D position of the physical camera where the 3D virtual environment includes a 3D representation of the surface and a representation of the markers on or above the surface according to their known 3D positions, and where the virtual camera's field of view is of a portion of the representation of the surface. For example, the alignment tool can base the initial 3D position of the virtual camera 120 on the inaccurate 3D position of the physical camera 130.

The process also includes correlating 430 one or more markers in the photographic image with one or more markers in the 3D virtual environment that appear in the virtual camera's field of view. For example, the alignment tool can correlate the first marker 150 with the second marker 160. Furthermore, the process includes adjusting 440 the initial 3D position of the virtual camera in the 3D virtual environment based on the disparity between the one or more markers' 3D positions in the photographic image as compared to the one or more markers' 3D positions in the virtual camera's field of view. For example, the alignment tool can adjust the initial 3D position of the virtual camera 120. In some implementations, based on the adjusted 3D position of the virtual camera, the process can superimpose the photographic image over the portion of the 3D virtual environment in the field of view of the virtual camera.

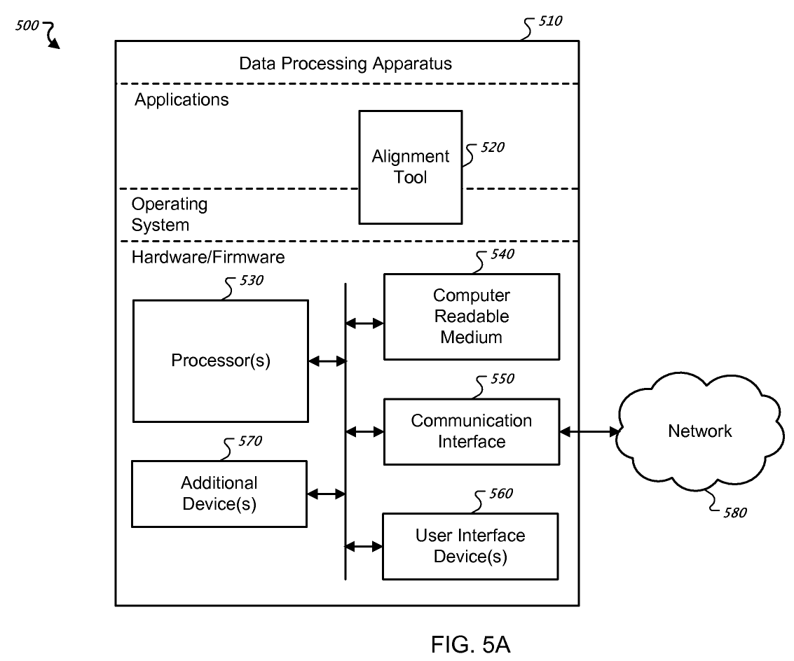

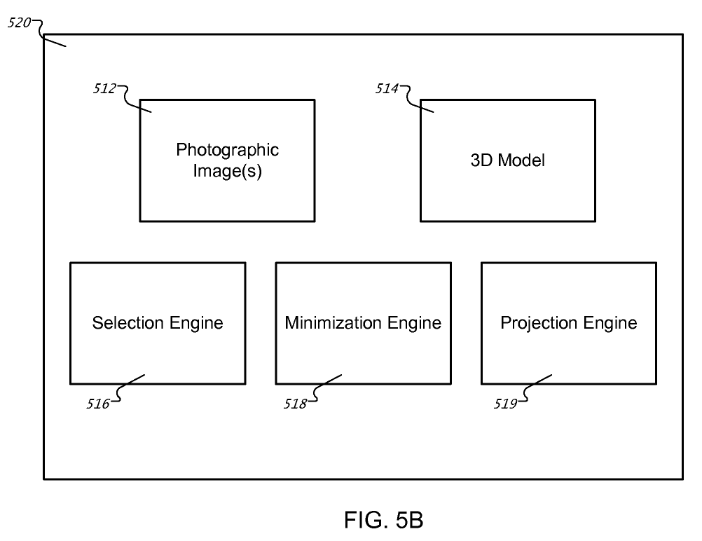

FIG. 5A is a schematic of an example system for aligning images. A data processing apparatus 510 can include hardware/firmware, an operating system and one or more programs or other software components, including an alignment tool 520. The alignment tool 520 can use the data processing apparatus 510, to effect the operations described in this specification. Temporarily referring to FIG. 5B, the alignment tool 510 can include photographic images 512, a 3D model 514 (e.g., a model of a 3D virtual environment), a selection engine 516, a minimization engine 518, and a projection engine 519. In some implementations, the selection engine 516 can be used to select a marker in the photographic image 512 that corresponds to a marker in the 3D model 514. The minimization engine 518 can minimize a disparity between the markers, and the projection engine 519 can determine a 3D position of the physical camera based on the minimized disparity. Though the software components and engines identified above are described as being separate or distinct, one or more of the components and/or engines may be combined in a single process or routine. The functional description provided herein including separation of responsibility for distinct functions is by way of example. Other groupings or other divisions of functional responsibilities can be made as necessary or in accordance with design preferences.

Returning to FIG. 5A, the alignment tool 520, in combination with one or more processors and computer-readable media (e.g., memory), represents one or more structural components in the system 500. The alignment tool 520 can be an application, or a portion thereof. As used here, an application is a computer program. An application can be built entirely into the operating system (OS) of the data processing apparatus 510, or an application can have one or more different components located in different locations (e.g., one portion in the OS or kernel mode, one portion in the user mode, and one portion in a remote server), and an application can be built on a runtime library serving as a software platform of the apparatus 510.

The data processing apparatus 510 includes one or more processors 530 and at least one computer-readable medium 540 (e.g., random access memory, or other storage device). The data processing apparatus 510 can also include a communication interface 550, one or more user interface devices 560, and one or more additional devices 570. The user interface devices 560 can include display screens, keyboards, mouse, stylus, or any combination thereof.

Once programmed, the data processing apparatus 510 is operable to perform the operations of process 400, for example. In some implementations, the data processing apparatus 510 can transmit data (e.g., 3D positions, images) or request data over the network 580.

Other implementations and applications of the described systems and techniques are possible. For example, the described systems and techniques can be used to determine more accurate positions of stereo cameras in a physical environment, and align stereo pair photographs of the physical environment captured by the stereo cameras with 3D virtual environments. As another example, photographic images associated with virtual cameras can be used to simulate movement through a computer generated virtual environment (e.g., a 3D virtual model).

In some implementations, the positions of the virtual cameras and the portions of the virtual environment can be used to select shots (e.g., photographic images portraying an associated virtual camera's field of view) to show a first-person view of a golf ball moving through a golf course, for example. As the accuracy of the 3D positions of the virtual cameras increase, a realism of movement through the virtual environment increases. For example, two frames of an animation can be generated from a first photographic image portraying a first FOV and a second photographic image portraying a second FOV. In order to generate a smooth transition between the two frames, the amount of change between the position of the first virtual camera and the position of the second virtual camera can, ideally, be minimized.

In some implementations, the positions of the virtual cameras and the portions of the virtual environment can be used to select shots to show different angles of the golf ball (e.g., points of view) as it moves through the golf course. For example, a trajectory of the golf ball can be divided into a plurality of portions. In a first portion, the camera angle can show the golf balls movement through the golf course from a view behind the golf ball (e.g., from the perspective of a player standing at the tee). In a second portion, the camera angle can show the golf ball's movement through the golf course from a side view of the golf ball (e.g., from the perspective of a spectator standing on the sidelines in the middle of the course). In a third portion, the camera angle can show the golf ball's movement through the golf course from a view in front of the golf ball (e.g., from the perspective of the hole).

In some implementations, the 3D positions of the virtual cameras and portions of the virtual environment in the FOVs of the virtual cameras can be used to select shots, e.g., to show different angles of the virtual environment according to a given position. For example, multiple 3D positions (e.g., different orientations) of a single virtual camera can be used to rotate a view of the virtual environment to see 360 degrees around a single position on the golf course. As another example, multiple virtual cameras disposed at different 3D positions around a golf ball, for example, can be used to rotate a view to see angles ranging from 0 to 360 degrees around a stationary golf ball. Other implementations are possible.

In some implementations, the positions of the virtual cameras can be plotted on a grid that corresponds to the virtual environment. The plotted grid can be used to determine statistics associated with the virtual cameras and the virtual environment, such as, but not limited to virtual camera coverage and density. A FOV of a virtual camera can be calculated based on a 3D position of the virtual camera and the virtual camera's sensor size and focal length. A representation of a FOV of each virtual camera (e.g., 125 and 135 of FIG. 1) can also be superimposed, with each corresponding virtual camera, on the grid to show virtual camera coverage. For example virtual camera coverage can be defined by an amount, or area, of the grid that has been captured in a photographic image. Virtual camera density can be defined, for example, as a number of virtual cameras plotted within a predetermined area of the grid (e.g., a predetermined number of cells).

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving an inaccurate three-dimensional (3D) position of a physical camera positioned above a surface in a physical environment corresponding to an actual 3D position of the physical camera where the physical camera captured a photographic image of the physical environment from the actual 3D position and where the photographic image includes a plurality of markers on or above the surface, each marker having a known 3D position on or above the surface;
basing an initial 3D position of a virtual camera in a 3D virtual environment on the inaccurate 3D position of the physical camera where the 3D virtual environment includes a 3D representation of the surface and a representation of the markers on or above the surface according to their known 3D positions, and where the virtual camera's field of view is of a portion of the representation of the surface;
correlating one or more markers in the photographic image with one or more markers in the 3D virtual environment that appear in the virtual camera's field of view; and
adjusting the initial 3D position of the virtual camera in the 3D virtual environment based on a disparity between the one or more markers' 3D positions in the photographic image as compared to the one or more markers' 3D positions in the virtual camera's field of view.

2. The method of claim 1, where the photographic image is a two-dimensional (2D) photographic image.

3. The method of claim 1, where the 3D position of the physical camera is defined by at least one of position data and attitude data.

4. The method of claim 1, where the one or more markers in the photographic image are visual markers.

5. The method of claim 1, where the one or more markers in the photographic image are virtual markers that are generated after the photographic image is captured.

6. The method of claim 1, further comprising:
superimposing the photographic image over the portion of the 3D virtual environment in the field of view of the virtual camera.

7. The method of claim 1, further comprising:
receiving input matching one or more of the one or more markers in the photographic image to one or more of the one or more markers in the virtual camera's field of view.

8. The method of claim 7, where the correlating includes:
minimizing the disparity based on the matching, producing a minimized disparity; and
generating a reverse projection of an adjusted 3D position of the virtual camera based on the minimized disparity.

9. The method of claim 8, further comprising:
generating a grid of the 3D virtual environment that includes the virtual camera configured according to the reverse projection.

10. The method of claim 9, further comprising:
calculating the field of view of the virtual camera; and
displaying a representation of the field of view on the grid.

11. A computer program product, encoded on a computer-readable medium, operable to cause one or more processors to perform operations comprising:
receiving an inaccurate three-dimensional (3D) position of a physical camera positioned above a surface in a physical environment corresponding to an actual 3D position of the physical camera where the physical camera captured a photographic image of the physical environment from the actual 3D position and where the photographic image includes a plurality of markers on or above the surface, each marker having a known 3D position on or above the surface;
basing an initial 3D position of a virtual camera in a 3D virtual environment on the inaccurate 3D position of the physical camera where the 3D virtual environment includes a 3D representation of the surface and a representation of the markers on or above the surface according to their known 3D positions, and where the virtual camera's field of view is of a portion of the representation of the surface;
correlating one or more markers in the photographic image with one or more markers in the 3D virtual environment that appear in the virtual camera's field of view; and
adjusting the initial 3D position of the virtual camera in the 3D virtual environment based on a disparity between the one or more markers' 3D positions in the photographic image as compared to the one or more markers' 3D positions in the virtual camera's field of view.

12. The computer program product of claim 11, where the photographic image is a two-dimensional (2D) photographic image.

13. The computer program product of claim 11, where the 3D position of the physical camera is defined by at least one of position data and attitude data.

14. The computer program product of claim 11, where the one or more markers in the photographic image are visual markers.

15. The computer program product of claim 11, where the one or more markers in the photographic image are virtual markers that are generated after the photographic image is captured.

16. The computer program product of claim 11, operable to cause one or more processors to perform operations further comprising:
superimposing the photographic image over the portion of the 3D virtual environment in the field of view of the virtual camera.

17. The computer program product of claim 11, operable to cause one or more processors to perform operations further comprising:
receiving input matching one or more of the one or more markers in the photographic image to one or more of the one or more markers in the virtual camera's field of view.

18. The computer program product of claim 17, where the correlating includes:
minimizing the disparity based on the matching, producing a minimized disparity; and
generating a reverse projection of an adjusted 3D position of the virtual camera based on the minimized disparity.

19. The computer program product of claim 18, operable to cause one or more processors to perform operations further comprising:
generating a grid of the 3D virtual environment that includes the virtual camera configured according to the reverse projection.

20. The computer program product of claim 19, operable to cause one or more processors to perform operations further comprising:
calculating the field of view of the virtual camera; and
displaying a representation of the field of view on the grid.

21. A system comprising:
a display device;
a machine-readable storage device including a program product; and
one or more computers operable to execute the program product, interact with the display device, and perform operations comprising:
receiving an inaccurate three-dimensional (3D) position of a physical camera positioned above a surface in a physical environment corresponding to an actual 3D position of the physical camera where the physical camera captured a photographic image of the physical environment from the actual 3D position and where the photographic image includes a plurality of markers on or above the surface, each marker having a known 3D position on or above the surface;
basing an initial 3D position of a virtual camera in a 3D virtual environment on the inaccurate 3D position of the physical camera where the 3D virtual environment includes a 3D representation of the surface and a representation of the markers on or above the surface according to their known 3D positions, and where the virtual camera's field of view is of a portion of the representation of the surface;
correlating one or more markers in the photographic image with one or more markers in the 3D virtual environment that appear in the virtual camera's field of view; and
adjusting the initial 3D position of the virtual camera in the 3D virtual environment based on a disparity between the one or more markers' 3D positions in the photographic image as compared to the one or more markers' 3D positions in the virtual camera's field of view.
